(19) United States
(12) Patent Application Publication
(10) Pub. No.: US 2009/0024324 A1
(43) Pub. Date: Jan. 22, 2009

(54) Method and System for GRR Testing

(76) Inventors: Douglas W. Clark, McKinney, TX (US); Nelson Kei Wai Leung, Plano, TX (US); Don Lloyd Simpson, Sherman, TX (US); Gary Glenn R. Dirige, Baguio City (PH); Martin Thomas Whitfield, Plano, TX (US)

Correspondence Address: TEXAS INSTRUMENTS INCORPORATED, P O BOX 655474, M/S 3999, DALLAS, TX, 75265, US

(21) Appl. No.: 11/781,110

(22) Filed: Jul. 20, 2007

(51) Int. Cl. G06F 19/00

(52) U.S. Cl. 702/1

(57) ABSTRACT

A method and a system for automatically performing gauge repeatability and reproducibility (GRR) tests is provided. A handler is used to automatically move semiconductor devices from a device tray or other storage device into position for testing. When operating in a GRR mode, the handler is configured to place each of the semiconductor devices being tested in each possible testing position. A series of tests is performed on each of the semiconductor devices being tested in each of the possible testing positions. Furthermore, the series of tests may be repeated multiple times for each of the semiconductor devices in each position. In this embodiment, it is preferred that the semiconductor devices be reseated after each completing each series of tests. The semiconductor devices may be individual dies, systems on chips, multi-chip modules, or wafers.

### TECHNICAL FIELD

The present invention relates generally to test systems and, more particularly, to a system and method for gauge reproducibility and repeatability measurements.

### BACKGROUND

Semiconductor dies, which are located in most electronic components, comprise millions of electrical components such as transistors, resistors, capacitors, diodes, and the like interconnected to provide multiple circuits. The current trend is to increase the density of electrical components and the circuits to provide smaller semiconductor dies that provide a greater number of functions, sometimes combining functionality that was on multiple semiconductor dies onto a single semiconductor die. As with any manufacturing process, it is desirable to test a die to ensure that the die correctly performs its functions.

To facilitate testing, manufacturers have developed testing procedures and equipment to test the semiconductor dies to verify that the semiconductor dies operate correctly. Generally, semiconductor dies are fabricated and then tested using automated testing equipment communicatively coupled to the pins or other external contacts of the semiconductor dies and assert pre-defined values on selected pins. Results of the tests are communicated to the test equipment via other pins or external contacts, and the test equipment evaluates the results to determine if the semiconductor dies passed the tests.

Because testing can be a time consuming process, test equipment has been developed that is configured to test multiple semiconductor dies simultaneously. Furthermore, it is not uncommon for a manufacturer to utilize multiple pieces of test equipment, simultaneously, wherein each piece of testing equipment is capable of test multiple semiconductor dies. The test results of each die may, however, vary depending upon which piece of test equipment is being used and where in the test equipment the device is being tested.

In an attempt to account for these variances, manufacturers have utilized gauge reproducibility and repeatability (GRR) methods. Generally, GRR methods measure the ability of an instrument to obtain similar results multiple times using the same test setup and different test setups. The GRR methods comprise a test engineer configuring the test equipment, performing a set of tests using a set of sample dies, and analyzing the results. The test engineer then manually re-performs the test multiple times using the same test setup. Thereafter, the test engineer changes the test setup and repeats the tests using the same set of sample dies. This process, however, is time consuming and very costly.

Accordingly, there is a need for an automated method and system for performing GRR tests in a time-efficient manner.

### SUMMARY OF THE INVENTION

These and other problems are generally solved or circumvented, and technical advantages are generally achieved, by preferred embodiments of the present invention which provides a system and method for performing gauge reproducibility and repeatability measurements.

In an embodiment of the present invention, a method of testing semiconductor devices is provided. The method includes providing semiconductor devices in a device tray and automatically moving the semiconductor devices from the device tray to a test head. The test head has a plurality of test sites. A set of tests is performed on the semiconductor devices, and then the semiconductor devices are automatically rearranged in the test head. Thereafter, the set of tests may be repeated. In this manner, the semiconductor devices may be tested in each of the positions of the test head. The tests may be repeated multiple times for each semiconductor device in each position. Preferably, the semiconductor devices are reseated between tests.

In another embodiment of the present invention, a test system is provided. The test system includes a controller communicatively coupled to a handler, and an IC tester communicatively coupled to the controller. The IC tester is configured to test a semiconductor device in a plurality of positions. A handler is communicatively coupled to at least one of the controller and the IC tester such that the controller or the IC tester may provide instructions to the handler to automatically retrieve each of the semiconductor devices for testing by the IC tester in each of the positions.

In yet another embodiment of the present invention, a computer program product for testing a plurality of semiconductor devices is provided. The computer program product causes a handler to move a set of semiconductor devices from a first location to a second location. The computer program product also causes the first set of semiconductor devices to be removed and then replaced in the second location. The computer program product causes the arrangement of the set of semiconductor devices to be changed. This process is repeated until each of the set of semiconductor devices have been tested in each position.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is a block diagram of a test environment in accordance with an embodiment of the present invention;

FIG. 2 is a block diagram of a processing system in accordance with an embodiment of the present invention;

FIGS. 3-4 are flow charts illustrating a process of performing gauge repeatability and reproducibility tests in accordance with an embodiment of the present invention; and

FIGS. 5a-5b are examples of semiconductor device arrangements that may be used in accordance with an embodiment of the present invention.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

The following description is described in the context of testing semiconductor dies using a quad-site 2×2 load board. The techniques described herein, however, may be applied to any testing of other types of devices and other types of configurations, including load boards having different sizes. Furthermore, it should be understood that techniques described herein may equally apply to testing a single die at a time, simultaneously testing multiple dies, testing performed at the wafer level, or the like. Techniques described herein may also be used in testing multi-chip modules and system-on-chip configurations.

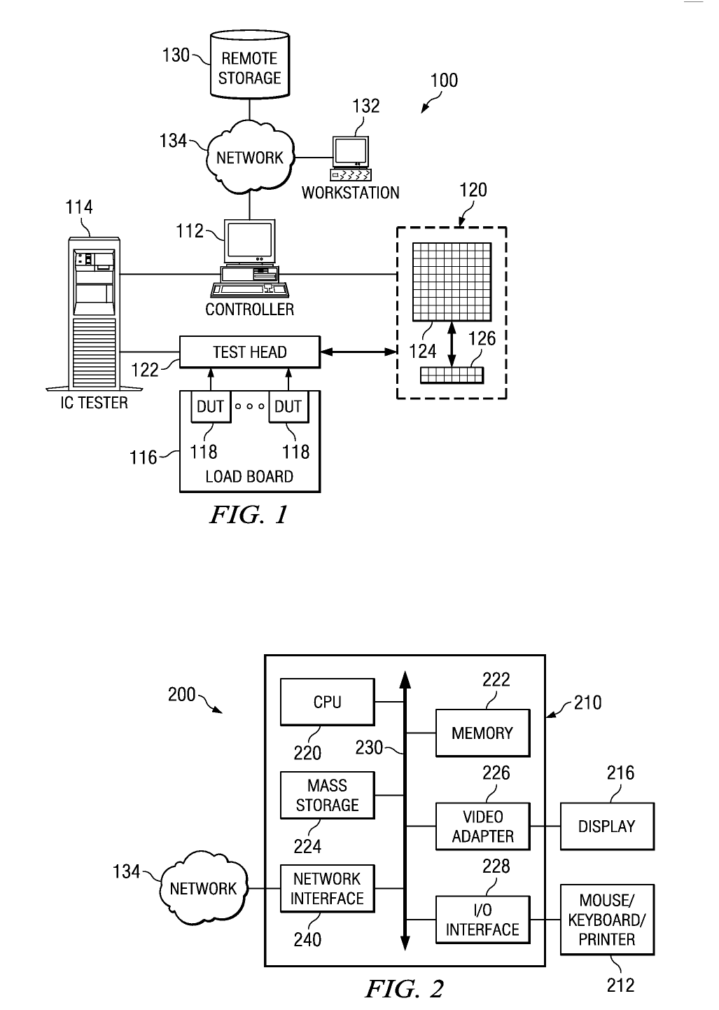

Referring first to FIG. 1, a test environment 100 in accordance with an embodiment of the present invention is illustrated. Generally, the test environment 100 includes a controller 112 communicatively coupled to an IC tester 114. The controller 112 provides instructions and test setup data to the IC tester 114, and the IC tester 114 provides test results and status information to the controller 112. The IC tester 114 is communicatively coupled to a test head 122, which is configured to electrically contact one or more devices under test (DUTs) 118, such as integrated circuits, system-on-chips (SOCs), multi-chip modules (MCMs), wafers, or the like, in a load board 116. In this manner, the controller 112 and the DUTs 118 are able to communicate test data and settings therebetween, allowing the controller 112 to cause the execution of specific tests by the DUTs 118 to test the functional operation of the DUTs 118.

The controller 112 is also communicatively coupled to a handler 120. Generally, the handler 120 includes robotic equipment that removes DUTs 118 from a device tray 124 and places them in a DUT transport 126. The DUTs 118 are then moved by the handler 120 from the DUT transport 126 to the load board 116, which holds the DUTs 118 in position to communicatively contact the test head 122.

It should be noted that the controller 112, the IC tester 114, the test head 122, and the handler 120 are illustrated as separate, distinct components only for illustrative purposes. One of ordinary skill in the art will realize that the controller 112, the IC tester 114, the handler 120, the test head 122, or a combination thereof may be incorporated into a single component. Furthermore, it should be noted that any component may be split into two or more components. For example, the controller 112 may be split into two controllers, one communicatively coupled to the IC tester 114 and one communicatively coupled to the handler 120. These two controllers may communicate therebetween.

It should also be noted that the size of the device tray 124, DUT transport 126, load board 116, and the test head 122 may be configured to be any size appropriate for the equipment and devices being utilized. The general trend today is to increase the number of DUTs that the test environment, including the device tray 124, DUT transport 126, and the test head 122, may test at any given point to expedite the testing cycle.

The test environment 100 may also include a remote storage facility 130 and/or a workstation 132 communicatively coupled to the controller 112. In an embodiment, the controller 112 is communicatively coupled to the remote storage facility 130 and/or the workstation 132 via a network 134, such as a local area network (LAN), wide area network (WAN), the Internet, a combination thereof, or the like. Generally, the workstation 132 may be used to access and analyze test results, develop test scripts, provide test data and setup instructions, control information/commands, and the like. The remote storage facility 130 may be utilized to, among other things, provide centralized storage for test results, test scripts, DUT specifications, test setup instructions, and the like. The remote storage facility 130 may be particularly useful in situations in which multiple test sites, controllers, handlers, and/or the like are networked together.

In operation, a user (not shown) causes the test environment 100 to enter into a GRR mode. The GRR mode, as will be discussed in greater detail below, allows a series of tests to be performed on each of a plurality of DUTs 118. The results of the series of tests allow a determination to be made regarding the repeatability and reproducibility, or the consistency, of the test environment 100. This is preferably performed in part by creating one or more test scripts to be performed by each DUT 118. The test scripts may be created off-line using the controller 112, the workstation 132, or the like and stored remotely on the remote storage facility 130, the workstation 132, or the like, or locally on the controller 112. Based upon the test scripts, the controller 112 provides instructions and setting information to the IC tester 114 and handler 120, thereby positioning the appropriate DUTs 118 and providing the necessary inputs to specific pins of the DUTs 118 via the load board 116. The IC tester 114 provides the controller 112 with the requested test results. The test results may be stored locally on the controller 112 or remotely, such as on the remote storage facility 130, for analysis.

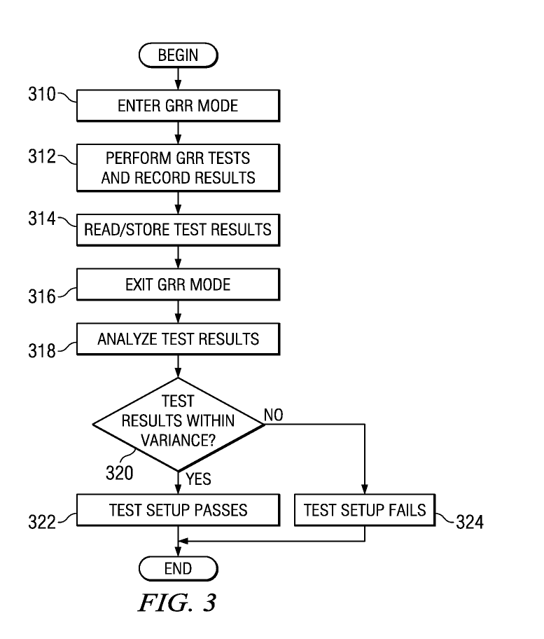

Referring now to FIG. 2, a block diagram of a processing system 200 is provided in accordance with an embodiment of the present invention. The processing system 200 is a general purpose computer platform and may be used to implement any or all of the controller 112, the handler 120, and/or the workstation 132. The processing system 200 may comprise a processing unit 210, such as a desktop computer, a workstation, a laptop computer, a personal digital assistant, a dedicated unit customized for a particular application, equipped with one or more input/output devices 212, such as a mouse, a keyboard, printer, or the like, and a display 216. The processing unit 210 may include a central processing unit (CPU) 220, memory 222, a mass storage device 224, a video adapter 226, and an I/O interface 228 connected to a bus 230.

The bus 230 may be one or more of any type of several bus architectures including a memory bus or memory controller, a peripheral bus, video bus, or the like. The CPU 220 may comprise any type of electronic data processor. For example, the CPU 220 may comprise a Pentium™ processor from Intel Corp., an Athlon processor from Advanced Micro Devices, Inc., a Reduced Instruction Set Computer (RISC), an Application Specific Integrated Circuit (ASIC), or the like. The memory 222 may comprise any type of system memory such as static random access memory (SRAM), dynamic random access memory (DRAM), synchronous DRAM (SDRAM), read-only memory (ROM), a combination thereof, or the like. In an embodiment, the memory 222 may include ROM for use at boot-up, and DRAM for data storage for use while executing programs.

The mass storage device 224 may comprise any type of storage device configured to store data, programs, and other information and to make the data, programs, and other information accessible via the bus 230. The mass storage device 224 may comprise, for example, one or more of a hard disk drive, a magnetic disk drive, an optical disk drive, or the like.

The video adapter 226 and the I/O interface 228 provide interfaces to couple external input and output devices to the processing unit 210. As illustrated in FIG. 2, examples of input and output devices include the display 216 coupled to the video adapter 226 and the mouse/keyboard/printer 212 coupled to the I/O interface 228. Other devices may be coupled to the processing unit 210, and additional or fewer interface cards may be utilized. For example, a serial interface card (not shown) may be used to provide a serial interface for a printer.

The processing unit 210 also preferably includes a network interface 240, which may be a wired link, such as an Ethernet cable or the like, and/or a wireless link. The network interface 240 allows the processing unit 210 to communicate with remote units via the network 134. In an embodiment, the processing unit 210 is coupled to a local-area network or a wide-area network to provide communications to remote devices, such as other processing units, the Internet, remote storage facilities, or the like.

It should be noted that the processing system 200 may include other components. For example, the processing system 200 may include power supplies, cables, a motherboard, removable storage media, cases, and the like. These other components, although not shown, are considered part of the processing system 200.

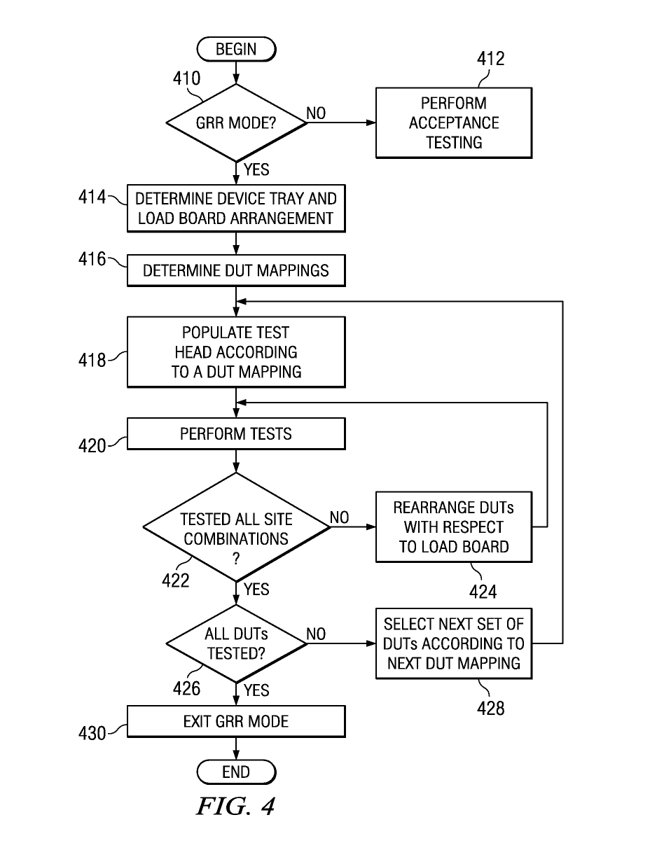

FIG. 3 is a flow chart illustrating the operation of the controller 112 in accordance with an embodiment of the present invention. The process begins in step 310, wherein a GRR mode is entered. This may include, for example, causing the IC tester 114 and/or the handler 120 to enter a GRR mode. As will be discussed in greater detail below, it may be desirable for the test environment 100 to operate differently when operating in the GRR mode as opposed to a production test environment. For example, during a GRR mode, it may be desirable to perform the same tests multiple times, seat and reseat the DUTs 118 on the test head 122, continue testing with faulty DUTs 118, or the like.

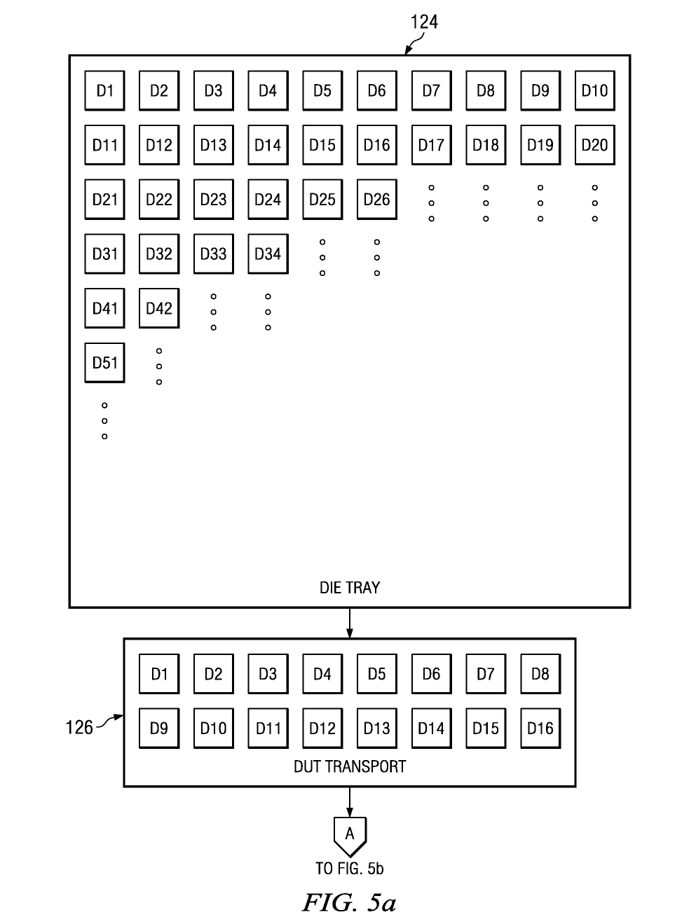

Once in the GRR mode, processing proceeds to step 312, wherein the GRR tests are performed and the results are recorded. Generally, performing the GRR tests comprises the controller 112 instructing the handler 120 to retrieve DUTs 118 from the device tray 124 and place them in the load board 116 in a specific order and assert test values on a pre-defined set of pins on the DUTs 118. Results are read from the DUTs 118 and communicated to the controller 112 for storage and later analysis in step 314. Performance of the GRR tests is described in greater detail below with reference to FIG. 4. Thereafter, the system may exit the GRR mode as illustrated in step 316

The results of the GRR tests may analyzed in step 318. The analysis of the tests results are preferably performed off-line after the GRR tests have been completed as illustrated in FIG. 3. In another embodiment, however, the GRR tests may be evaluated real-time as the GRR are performed.

Upon completion of the GRR tests, a determination is made whether or not the test results of the DUTs 118 are within a pre-defined variance in step 320. If the test results of the DUTs 118 are within a pre-defined variance, then the test setup is verified as being sufficient to use in a production environment in step 322. Otherwise, in step 320 if the test results of the DUTs 118 are not within the pre-defined variance, then the test setup is not verified as being sufficient to use in a production environment in step 324.

FIG. 4 is a flow chart illustrating a process that may be performed by the controller 112, the IC tester 114, and/or the handler 120 in accordance with an embodiment of the present invention. It should be noted that the process described herein may be performed on any one or combination of components described with reference to FIG. 1. It should be noted, however, that in a preferred embodiment, the process discussed below with reference to FIG. 4 is performed by the handler 120.

The process begins in step 410, wherein a determination is made whether or not the testing system is operating in a GRR mode. The determination may be based upon a software command sent from another component, such as the controller 112, IC tester 114, a software command or hardware switch entered directly on the handler 120, or the like.

If a determination is not operating in a GRR mode, then processing proceeds to step 412 to perform acceptance testing, such as that which may be performed in a production environment. Otherwise, processing proceeds to step 414 to begin the GRR testing procedure.

In step 414, a device tray and load board arrangement is determined. As discussed above, the device tray 124 (see FIG. 1) holds the DUTs 118 in preparation to begin testing. In an embodiment in which semiconductor dies are being tested, the device tray 124 holds the semiconductor dies in a pre-defined order and arrangement. The device tray arrangement may be retrieved from a data file stored either locally or electronically, a user input entered on the controller 112, IC tester 114, or the handler 120, determined from a scanning procedure (such as a UPC symbol or an RFID tag), or the like.

The handler removes the DUTs 118 from the device tray 124 and places them in a load board 116 in preparation of testing the DUTs 118. The test head 122 (see FIG. 1) may be of any size and arrangement compatible with the load board 116. For example, load boards 116 having a size and arrangement of a 1×4 array, a 2×2 array, or the like have been used. Other sizes may be used, and the trend is to use larger sizes in order to test more DUTs 118 simultaneously.

Once the device tray and the load board arrangement are determined, the DUT mappings may be determined in step 416. For each device tray arrangement and load board arrangement, a pre-defined order or mapping for placing the DUTs 118 into the load board 116 is retrieved. The DUT mappings may be retrieved locally or remotely. The handler 120 then automatically populates the load board 116 in step 418 by removing DUTs 118 from the device tray 124 and/or the DUT transport 126 and placing the DUTs in the load board 116 in accordance with the DUT mappings.

In step 420, the DUTs 118 in the load board 116 are tested. Testing includes bringing the DUTs 118 in the load board 116 into contact with the test head 122. The test head 122, along with the IC tester 114 and the controller 112, provides input to and reads results from the pins of the DUTs 118 to perform a series of tests, which tests functionality of the DUTs 118. In an embodiment, the series of tests is performed multiple times and is preferably performed at least three times. Furthermore, it is preferred that the DUTs 118 be removed from the load board 116/test head 122 and re-seated onto the load board 116/test head 122 between each series of tests.

In step 422, a determination is made whether or not each DUT 118 has been tested in each site of the load board 116 and/or the test head 122. If a determination is made that each DUT 118 has not been tested in each site of the load board 116 and/or the test head 122, then processing proceeds to step 424 wherein the DUTs 118 on the load board 116 are rearranged. The handler 120 through the use of robotic equipment automatically removes the DUTs 118 from the load board 116 and places them into the DUT transport 126 temporarily according to the DUT mappings determined in step 416. The DUTs 118 are then placed by handler 120 back into the load board 116, but in a different position, also according to the DUT mappings. Once rearranged, processing returns to step 420, wherein the GRR tests are performed with the DUTs 118 in the different position.

It should be noted that it is desirable that failed DUTs not be removed from testing. As indicated above with reference to steps 316-320, an object of GRR testing is to test each DUT in each position multiple times for each tester, and to compare those results from each die in each position in each tester to determine whether or not the test system is able to achieve satisfactory reproducibility and repeatability. Accordingly, whether a test failed may be irrelevant if the same results are returned to the same die in each position. Also, if a test failed for every die only when tested in a specific position, this may indicate a problem with the test equipment.

If, in step 422, a determination is made that the current set of DUTs 118 loaded in the test head 122 have been tested in each site of the load board 116 and/or the test head 122, then processing proceeds to step 426, wherein a determination is made whether or not all of the DUTs 118 in the device tray 124 have been tested. While the process described above tests one set of DUTs 118 in each of the possible positions of a load board 116 and/or the test head 122, it may be desirable to test multiple sets of DUTs 118 in order to gain a larger statistical sample. Accordingly, in step 428 a different set of DUTs 118 may be selected to be tested.

It should be noted that this step may include loading a different set of DUTs 118 from the DUT transport 126 into the load board 116 or may include loading the DUT transport 126 with different DUTs 118 from the device tray 124 and then loading a different set of DUTs 118 from the DUT transport 126 into the load board 116.

If in step 426 a determination is made that all DUTs 118 have been tested, then processing proceeds to step 430, wherein the GRR test mode is exited.

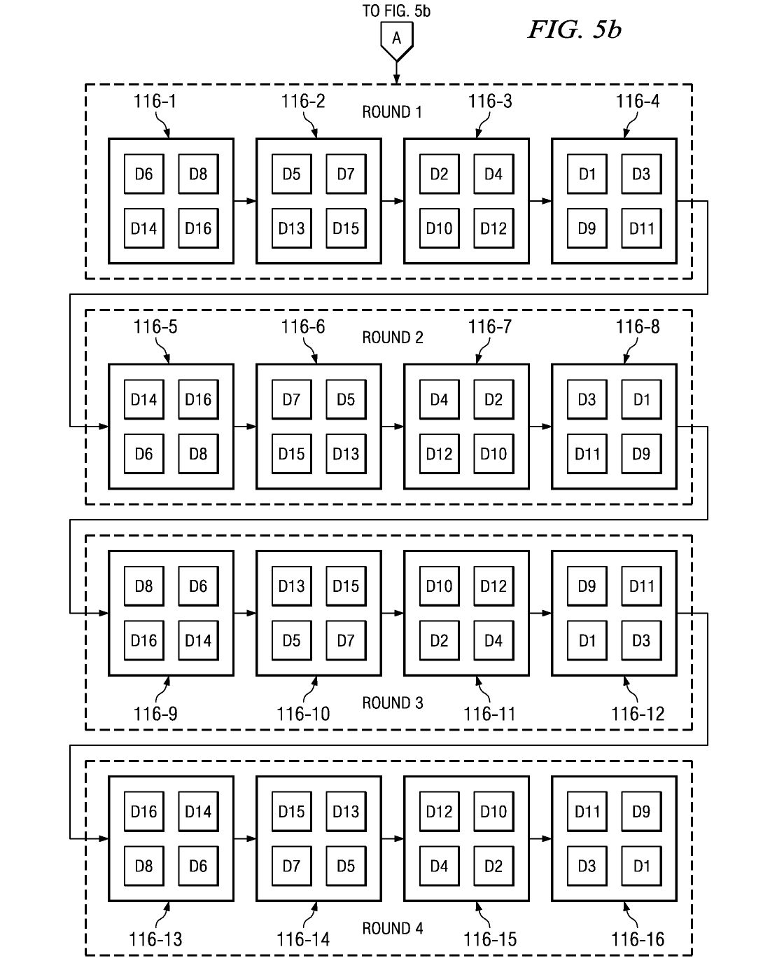

FIGS. 5a-5b illustrate the placement of dies in a device tray 124, DUT transport 126, and individual test sites of a load board 116 in accordance with an embodiment of the present invention. Initially, the dies D1-D51+ are placed in a device tray 124. A 10×10 device tray is illustrated in FIG. 5a for illustrative purposes only, but other sizes and configurations of device trays may be used.

The handler 120 automatically removes the selected dies from the device tray 124 and places the selected dies in pre-assigned places in the DUT transport 126. In the example illustrated in FIG. 5a, sixteen dies, D1-D16, have been moved from the device tray 124 to the DUT transport 126. Thereafter, sets of dies are moved from the DUT transport 126 to the load board 116. In this example, the load board 116 is configured to accommodate four DUTs 118 at a time in a 2×2 configuration. Other configurations may be used for the DUT transport 126 and/or the load board 116.

FIG. 5b illustrates load board configurations 116-1 to 116-16 organized into four rounds, Round 1-4, wherein each round tests each of the DUTs 118 loaded into the DUT transport 126 in a single position of the load board 116. It should be noted, however, that the particular order and the arrangement of the tests are only provided for illustrative purposes. The DUTs 118 may be placed and tested in any appropriate order, but the placement and order is preferably arranged such that each DUT 118 is tested in each of the positions of the load board 116 with the fewest number of steps. For example, FIG. 5b illustrates that die D1 is tested in the upper-left location in load board configuration 116-4, tested in the upper-right location in load board configuration 116-8, tested in the lower-left location in load board configuration 116-12, and tested in the lower-right location in load board configuration 116-16.

In an alternative embodiment, each of the four rounds completely tests a set of dies in each of the positions of a load board 116. For example, the testing may be configured such that configurations 116-1, 116-5, 116-9, and 116-13 are tested sequentially in Round 1, configurations 116-2, 116-6, 116-10, and 116-14 are tested sequentially in Round 2, etc. As one of ordinary skill in the art will appreciate, other sequences may also be used.

As noted above, it is preferred that each test configuration be tested multiple times. This may be accomplished by sequentially performing Round 1 and then repeating it multiple times, immediately repeating each test configuration (e.g., sequentially testing 116-1, 116-1, 116-1, 116-2, 116-2, 116-2, 116-3, . . . ), sequentially repeating Rounds 1-4 (e.g., sequentially testing Round 1, Round 2, Round 3, Round 4, Round 1, Round 2, . . . ), or the like. Regardless of the sequence of testing, it is preferred that each DUT 118 be re-seated between each test sequence.

It should be noted that the data flow diagrams illustrated herein are provided at high level to communicate the concepts and an implementation of an embodiment of the present invention. One of ordinary skill in the art will realize that numerous details and steps have been omitted for the sake of clearly conveying the inventive concepts of the present invention. It should also be noted that numerous additions may be made, the ordering modified, different techniques may be used, and the like and yet remain within the scope of the present invention.

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of testing semiconductor devices, the method comprising:
providing a plurality of semiconductor devices in a device tray;
automatically moving a first subset of the plurality of semiconductor devices from the device tray to a load board, the first subset of the plurality of semiconductor devices being arranged in a first arrangement in the load board, the load board having multiple test sites;
performing a set of tests on the first subset of the plurality of semiconductor devices;
automatically rearranging the first subset of the plurality of semiconductor devices from the first arrangement to a second arrangement; and
repeating the one or more tests.

2. The method of claim 1, wherein the performing a set of tests is repeated multiple times on the first subset of the plurality of semiconductor devices in the first arrangement.

3. The method of claim 2, further comprising reseating the first subset of the plurality semiconductor devices between performing the set of tests.

4. The method of claim 1, wherein the repeating the one or more tests is repeated until each semiconductor device of the first subset is tested each of the test sites of the load board.

5. The method of claim 1, wherein the automatically rearranging is performed at least in part by a handler communicatively coupled to a controller, the handler automatically removing the first subset of the plurality of semiconductor devices from the load board and inserting the first subset of the plurality of semiconductor devices into the load board in the second arrangement.

6. The method of claim 5, further comprising temporarily placing the first subset of the plurality of semiconductor devices in a DUT transport between the automatically removing and the inserting.

7. The method of claim 1, wherein the semiconductor devices comprise individual dies.

8. The method of claim 1, wherein the semiconductor devices comprise wafers, each wafer having a plurality of semiconductor dies.

9. A test system comprising:
a controller communicatively coupled to a handler;
an IC tester communicatively coupled to the controller, the IC tester being configured to test a semiconductor device in a plurality of positions; and
a handler communicatively coupled to at least one of the controller and the IC tester, at least one of the controller and IC tester providing instructions to the handler to automatically retrieve each of a plurality of semiconductor devices for testing by the IC tester in each available position.

10. The test system of claim 9, wherein the IC tester is configured to repeat a series of tests multiple times on each of the plurality of semiconductor devices in each position.

11. The test system of claim 10, wherein the handler is further configured to reseat each of the plurality of semiconductor devices between each series of tests.

12. The test system of claim 9, wherein the semiconductor device comprises an individual die.

13. The test system of claim 9, wherein the semiconductor device comprises a wafer, each wafer having a plurality of semiconductor dies.

14. The test system of claim 9, wherein the semiconductor device includes multiple semiconductor dies.

15. A computer program product for testing a plurality of semiconductor devices, the computer program product having a medium with a computer program embodied thereon, the computer program product comprising:
(A) computer program code for causing a handler to move a first set of the semiconductor devices from a first arrangement at a first location to a second arrangement at a second location, the second location having a plurality of test sites;
(B) computer program code for removing the first set of semiconductor devices from the second location and replacing the first set of semiconductor devices in the second location;
(C) computer program code for moving the first set of semiconductor devices from the second arrangement to a third arrangement at the second location; and
(D) computer program code for repeating (B)-(C) until each of the first set of semiconductor devices have been tested in each of the plurality of test sites.

16. The computer program product of claim 15, wherein the moving comprises computer program code for temporarily placing the first set of semiconductor devices in a DUT transport.

17. The computer program product of claim 15, further comprising computer program code for performing a series of tests on the first set of semiconductor devices in each arrangement.

18. The computer program product of claim 17, wherein the computer program code for performing is performed multiple times.

19. The computer program product of claim 18, wherein the computer program code for removing and replacing is performed after each series of tests.

20. The computer program product of claim 19, wherein the computer program code for repeating (A)-(C) continues regardless of results of the performing a series of tests.
